(19) United States
(12) Patent Application Publication
(10) Pub. No.: US 2021/0244991 A1
(43) Pub. Date: Aug. 12, 2021

(54) EXERCISE MAT

(71) Applicant: Shawn PICKETT, St. Charles, IL (US)

(72) Inventor: Shawn PICKETT, St. Charles, IL (US)

(21) Appl. No.: 17/169,041

(22) Filed: Feb. 5, 2021

Related U.S. Application Data
(60) Provisional application No. 62/971,698, filed on Feb. 7, 2020.

(51) Int. Cl. A63B 6/00; H01F 7/02

(52) U.S. Cl. CPC A63B 6/00; H01F 7/02

(57) ABSTRACT

A mat includes a mat base defined by a length and a width, the length being greater than the width. The mat includes a first plurality of magnets coupled to a first surface of the mat base, and a second plurality of magnets coupled to a second surface of the mat base.

### CROSS-REFERENCE TO RELATED PATENT APPLICATION

The present application claims the benefit of and priority to U.S. Provisional Application No. 62/971,698 filed Feb. 7, 2020, the entire disclosure of which is incorporated by reference herein.

### BACKGROUND

The present disclosure relates generally to an exercise mat. More specifically, the present disclosure relates to an exercise mat that includes features to facilitate easy rolling and storage of the mat.

Generally speaking, some exercise mats are flexible and are configured to be rolled into a substantially cylindrical shape for storage or transport. For example, a yoga mat may be rolled into a substantially cylindrical shape by a user to be placed in, for example, a storage receptacle (e.g., a sleeve, a carrying bag, elastic straps, a backpack, etc.) for storing and/or transporting the yoga mat. However, it can be difficult to properly roll the mat into a cylindrical shape for subsequent storage, which can result in the mat being lopsided or “telescoped.” In addition, the mat can easily unroll since the mat has a tendency to return to its unrolled position. Even if the mat is properly rolled, the mat is unlikely to be rolled in a tight enough position to fit into a storage receptacle.

Therefore, there is a need for an exercise mat that can be rolled up into a consistent shape without unrolling and with minimal effort.

### SUMMARY

One exemplary embodiment of the present disclosure relates to a mat comprising a mat base defined by a length and a width, the length being greater than the width; a first plurality of magnets coupled to a first surface of the mat base; and a second plurality of magnets coupled to a second surface of the mat base.

Another exemplary embodiment of the present disclosure relates to a mat comprising a mat base defined by a length and a width, the length being greater than the width; and a dowel coupled to a first end of the mat, wherein the mat is configured to be rolled around the dowel along the length of the mat.

Another exemplary embodiment of the present disclosure relates to a method for manufacturing a mat, the method comprising providing a mat base defined by a length and a width, the length being greater than the width; coupling a first plurality of magnets to a first surface of the mat base; and coupling a second plurality of magnets to a second surface of the mat base opposite the first surface.

This summary is illustrative only and is not intended to be in any way limiting.

### BRIEF DESCRIPTION OF THE FIGURES

FIG. 1 is front view of a mat assembly, according to an exemplary embodiment.

FIG. 2 is a front view of the mat assembly, according to an exemplary embodiment.

FIG. 3A is a front view of the mat assembly of FIG. 1 shown with a plurality of magnets.

FIG. 3B is a back view of the mat assembly of FIG. 1 shown with a plurality of magnets.

FIG. 3C is a side view of the mat assembly of FIG. 1 shown in a partially-rolled position.

FIG. 4 is a front view of the mat assembly shown with magnetic strips, according to another exemplary embodiment.

FIG. 5 is a front view of the mat assembly shown with a plurality of booster magnets, according to another exemplary embodiment.

FIG. 6 is a front view of the mat assembly shown with a plurality of booster magnets, according to another exemplary embodiment.

FIG. 7 is a side view of the mat assembly of FIG. 1 shown in a partially-rolled position, according to another exemplary embodiment.

### DETAILED DESCRIPTION

Before turning to the FIGURES, which illustrate certain exemplary embodiments in detail, it should be understood that the present disclosure is not limited to the details or methodology set forth in the description or illustrated in the FIGURES, it should also be understood that the terminology used herein is for the purpose of description only and should not be regarded as limiting.

Referring generally to the FIGURES, disclosed herein is a mat assembly (e.g., exercise mat, yoga mat, etc.) including features that can facilitate a quicker and easier roll-up process for stowing and/or transporting the mat. According to an exemplary embodiment, the mat assembly includes a dowel coupled to an end of the mat such that the mat can maintain a more consistent position relative to itself as it is being rolled and can help prevent the mat from rolling in a lopsided manner and ‘telescoping,’ as is the case with most conventional mats. Further, the dowel serves to apply downward pressure on the mat as it rolls, forcing out excess air and creating a tighter roll. In some embodiments, the self-rolling mat includes one or more magnets coupled to the mat along the peripheral sides of the mat such that magnets located closer to the dowel will be attracted to and couple to magnets located farther away from the dowel, so as to help propel the dowel forward to roll the mat around the dowel. The use of magnets not only provides additional rolling force, but also ensures a tighter and more consistent roll, as the magnets can help maintain a rolled position of the mat and help prevent unrolling.

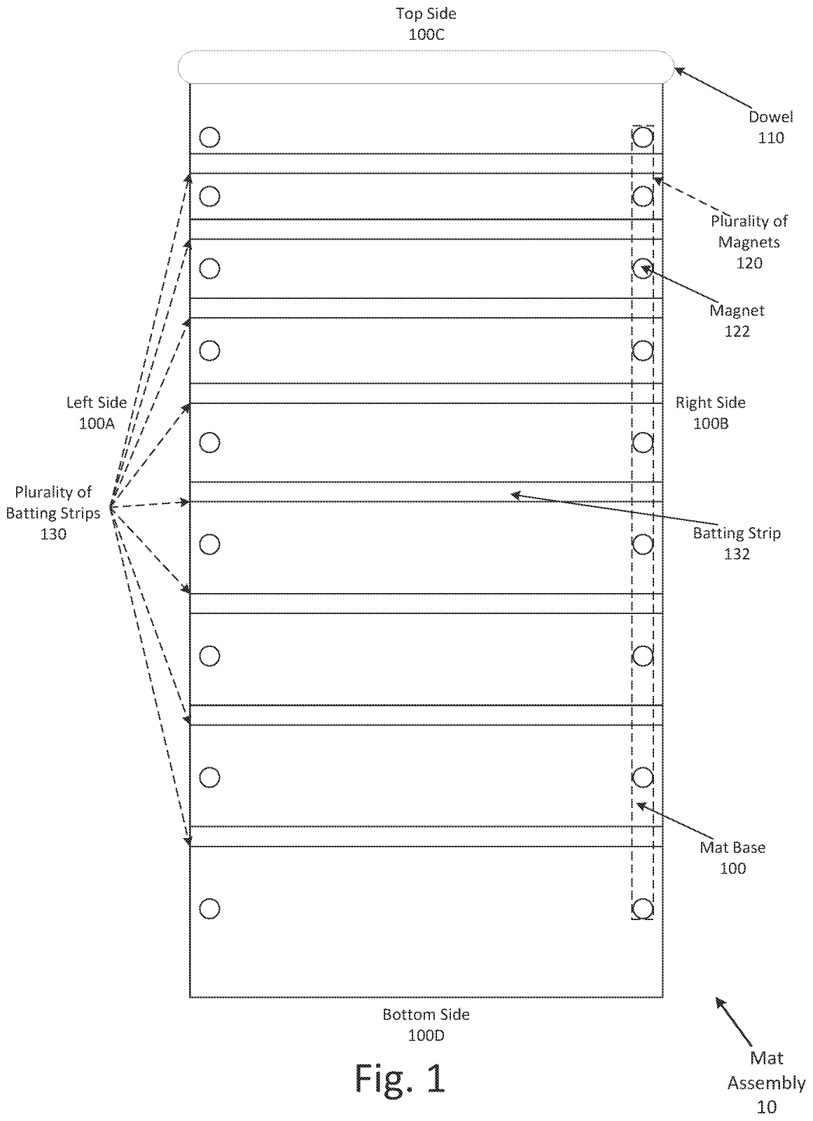

Referring to FIG. 1, the mat assembly 10 includes a mat base 100, a dowel 110, a plurality of magnets 120, and a plurality of batting strips 130. The mat base 100 has a left side 100A, a right side 100B, a top side 100C, and a bottom side 100D. The left side 100A and the right side 100B each have length L, while the top side 100C and the bottom side 100D each have width W. In these embodiments, the length L is greater than the width W such that the mat base 100 forms a generally rectangular shape. The mat base 100 is generally planar. According to an exemplary embodiment, the mat base 100 is made from a single layer of a flexible and compressible material. In other embodiments, the mat base 100 is formed as a stack of multiple layers of material such that the comfort and cushion provided by the mat base 100 is increased. The dowel 110 is coupled at the periphery of the top side 100C and, in some embodiments, is a separate component from the mat. The dowel 110 may be made of metal, wood, plastic, or any other rigid material or combinations of materials. According to an exemplary embodiment, the dowel 110 is coupled to the mat base 100 (e.g., using adhesive, etc.). In other embodiments, the dowel 110 is integrally formed as part of the mat base 100 and may be made of the same material as the mat base 100.

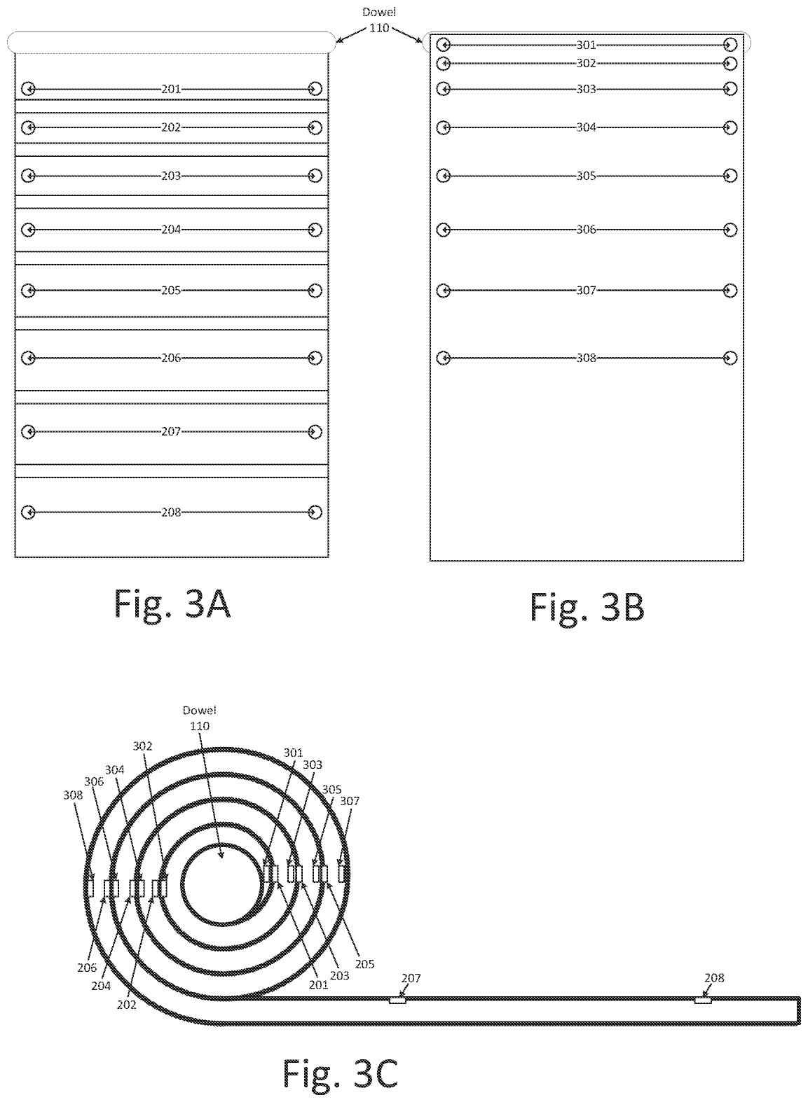

As shown in the embodiment of FIG. 1, the mat base 100 includes a plurality of magnets 120. It should be appreciated that the mat assembly 10 may include the dowel 110 without the plurality of magnets 120 or vice versa, according to other exemplary embodiments. According to an exemplary embodiment, the plurality of magnets 120 are coupled along each of the left side 100A and the right side 100B and are spaced in gradually increased intervals, such that as the mat base 100 is rolled and the circumference of the rolled-up mat base 100 increases, each of the plurality of magnets 120 will substantially overlap and bias toward a corresponding magnet on the mat base 100, so as to account for this increased circumference. This is shown in greater detail in FIGS. 3A-C. For example, as shown in FIG. 3A, the space between the sets of the plurality of magnets labelled 201 and 202 is smaller than the space between the sets of the plurality of magnets labelled 202 and 203, which is itself smaller than the space between the sets of the plurality of magnets labelled 203 and 204. This is similarly shown in FIG. 3B, where the space between the sets of the plurality of magnets labelled 301 and 302 is smaller than the space between the sets of the plurality of magnets labelled 302 and 303. This increase in space between sets of the plurality of magnets 120 is directly and mathematically related to the increase in circumference of the mat base 100 as it rolls around the dowel 110. For example, the space between sets of the plurality of magnets 120 may be based on radian angle, such that each set of the plurality of magnets 120 is separated by a radian angle of 45° when the mat assembly 10 is rolled up. In some embodiments, the space between sets of the plurality of magnets 120 is at least about 2 cm.

According to an exemplary embodiment, the plurality of batting strips 130 are coupled to the mat base 100 in a substantially parallel orientation relative to the top side 100C and are of a similar width W as the mat base 100. As shown in FIG. 1, each batting strip 132 of the plurality of batting strips 130 is positioned in between a pair of the plurality of magnets 120. However, in other embodiments, the plurality of batting strips 130 may be positioned differently, such as in between every other magnet 122 of the plurality of magnets 120. By being oriented parallel to the top side 100C and to the dowel 110, the plurality of batting strips 130 serve to provide additional structural support for the mat assembly 10 in a substantially perpendicular direction relative to the rolling force as the mat assembly 10 is rolled, so that the integrity and tightness of the roll is preserved throughout the rolling process. For example, as a rolling force is applied to the dowel 110 and the mat base 100 begins to roll up around the dowel 110, the plurality of batting strips 130 will help keep the mat base 100 from rolling unevenly and telescoping by adding stiffness to the mat base 100. In some of the embodiments that include the plurality of batting strips 130, relief scores may be added to each batting strip 132 in order to make use of the added stiffness from the plurality of batting strips 130 without encumbering the rolling ability of the mat base 100. These relief scores are slight indentations in each batting strip 132 that increase the folding or bending ability of the batting strip 132 across the axis formed by the relief strip, so that by orienting the relief scores in parallel with the dowel 110, the plurality of batting strips 130 will more easily bend and roll with the mat base 100 while still providing additional support and structure to the mat.

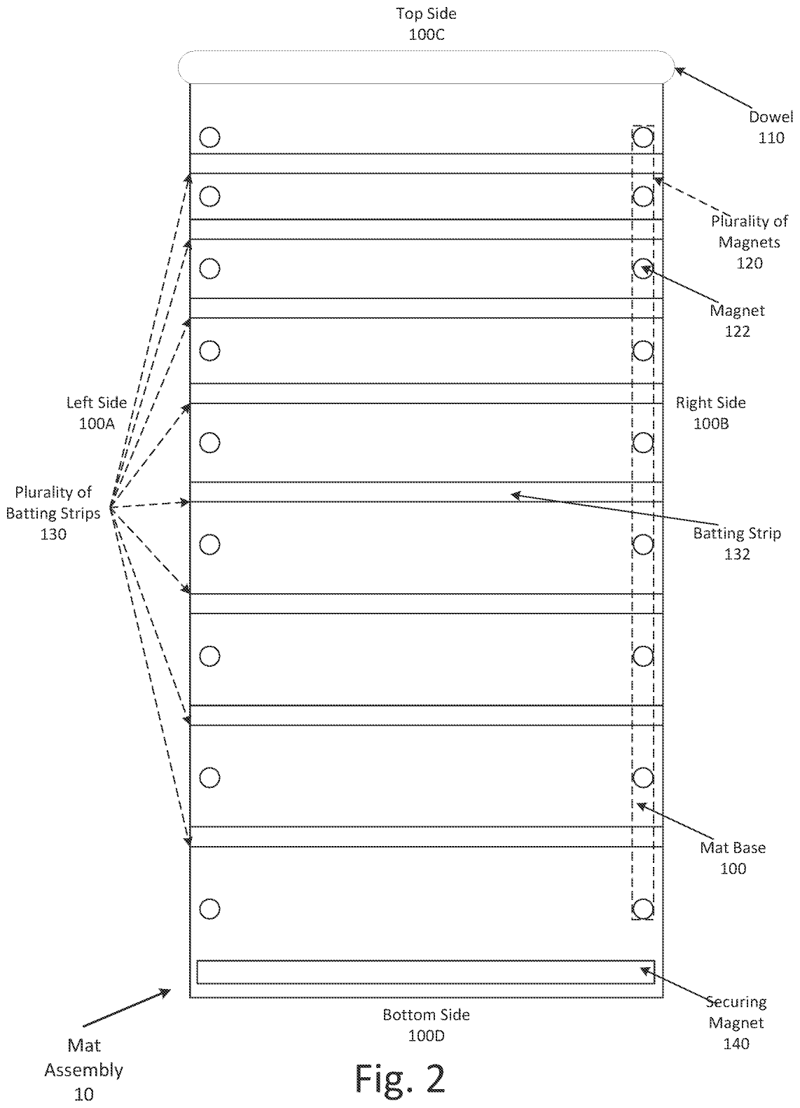

In some embodiments, a securing magnet 140 is coupled to the mat base 100 immediately proximate to the bottom end 100D, and is configured to hold the mat in a fully rolled-up position once the rolling process has been completed. This is shown in FIG. 2, which is a front view of the mat assembly 10 showing the securing magnet 140. Although the securing magnet 140 is shown in FIG. 2 as a strip that runs the width W of the mat base 100 and is parallel to the bottom end 100D, in alternative embodiments, the securing magnet 140 can be a shorter strip (i.e., a strip that runs only a portion of the width W), a single substantially-circular magnet (i.e., similar to the plurality of magnets 120), a plurality of magnets, or any other arrangement of magnets suitable for maintaining the mat in a rolled-up position. Further, as shown in FIG. 2, the securing magnet 140 is coupled to a front surface of the mat base, and a corresponding magnet (not shown) is coupled to a rear surface of the mat, such that the securing magnet 140 and the corresponding magnet interface with each other when the mat is in the fully rolled-up position. Because the securing magnet 140 and the corresponding magnet are of opposite polarities, when the securing magnet 140 and the corresponding magnet interface (e.g., when the mat is in the fully rolled-up position), the securing magnet 140 and the corresponding magnet are magnetically coupled.

In some embodiments, the plurality of magnets 120 are coupled to both a first surface (e.g., front surface) and a second surface (e.g., rear surface) of the mat base 100, such that the plurality of magnets 120 are arranged with one polarity on the front of the mat base 100 and the plurality of magnets with the opposite polarity are on the back of the mat base. This is shown in FIG. 3A, which is a front view of the mat assembly 10 showing a first plurality of magnets 201-208 having a first operative magnetic direction (i.e., either the North or South pole of the magnet being stronger and/or closer to the surface, such that each of the first plurality of magnets operate outwardly with either North or South polarity), and FIG. 3B, which is a back view of the mat assembly 10 showing a second plurality of magnets 301-308 having a second operative magnetic direction (i.e., either the North or South pole of the magnet being stronger and/or closer to the surface, such that each of the second plurality of magnets operate outwardly with either North or South polarity) that is opposite of the first operative magnetic direction (i.e., if the first plurality of magnets are operatively North, then the second plurality of magnets are operatively South). The mat assembly 10 is configured such that as the mat base 100 is rolled up, one of the first plurality of magnets 201-208 will bias toward and couple to one of the second plurality of magnets 301-308.

In some embodiments, each magnet 122 in each set of the plurality of magnets 201-208 and 301-308 are individual magnets (or self-contained set of magnets) utilizing a Halbach array (e.g., similar to a standard refrigerator magnet) such that each magnet 122 projects only one magnetic field with a desired polarization. For instance, in one example embodiment, each magnet 122 in the set of the plurality of magnets 201 is constructed using a Halbach array to give each magnet 122 a stronger positive magnetic field and a neutralized negative magnetic field, while each magnet 122 in the set of the plurality of magnets 301 is constructed using a Halbach array to give each magnet 122 a stronger negative magnetic field and a neutralized positive magnetic field. In other embodiments, the plurality of magnets 120 are each defined by a single magnet having two opposed surfaces with opposite polarities (i.e., a bipole magnet with North and South polarities). The first surface is arranged to be exposed on the front surface of the mat base 100 (i.e., the first operative magnetic direction) and the second surface is arranged to be exposed on a rear surface of the mat base 100 (i.e., the second operative magnetic direction), such that the magnets 201-206 and 303-308 correspond with each other in positioning, as shown in FIGS. 3A-C. In other embodiments, corresponding magnets in the first plurality of magnets 201-206 and in the second plurality of magnets 303-308 are opposite poles of a single dipole magnet, such that the first plurality of magnets 201-206 and the second plurality of magnets 303-308 together form a plurality of dipole arrays.

FIG. 3C illustrates the mat assembly 10 in a partially-rolled position. Once the rolling process is initiated with an applied force to the dowel 110 (e.g. user kicks the dowel, etc.), each of the magnets of the plurality of magnets 301 on the back side of the mat is attracted to and coupled with a corresponding magnet of the plurality of magnets 201 on the front side of the mat. The magnetic biasing force, combined with any residual force from the initial kick, propels the dowel 110 forward, which can help roll the mat base 100 against itself and the dowel 110, and can bring the set of the plurality of magnets 302 closer to the set of the plurality of magnets 202. When the magnets are close enough to each other, the plurality of magnets 302 will couple to the corresponding magnets 202, which drives the dowel 110 forward with additional force. This process continues with the sets of magnets 303-308 and 203-208 until the mat assembly 10 is completely rolled.

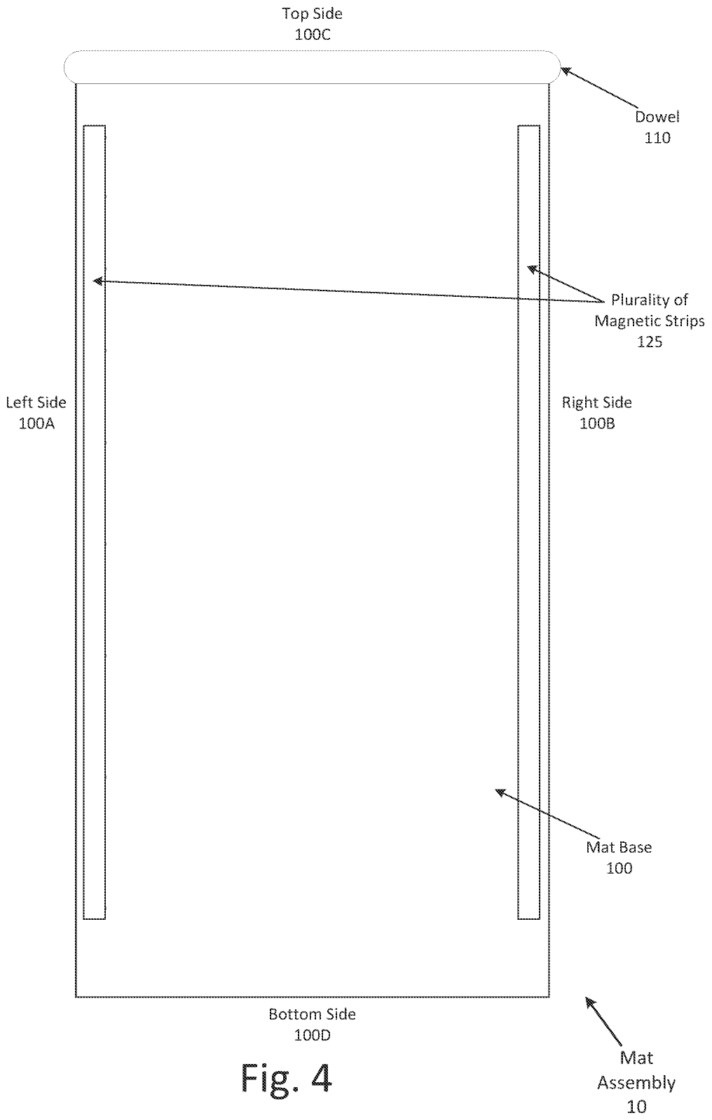

As shown in FIG. 4, the mat assembly 10 may include a plurality of magnetic strips 125 instead of the plurality of magnets 120 and the plurality of batting strips 130 according to another exemplary embodiment. These plurality of magnetic strips 125 function similarly to the plurality of magnets 120 in that the plurality of magnetic strips 125 are located on both the front side and the back side of the mat base 100 with opposite polarities. After force is applied to the dowel 110 and the mat base 100 begins to roll, the plurality of magnetic strips 125 on the back side of the mat base 100 become attracted to and couple with the plurality of magnet strips 125 on the front side of the mat base 100.

In some embodiments, there are multiple pairs of magnetic strips 125 that are aligned in parallel with each other and form rows parallel to the top side 100C and the bottom side 100D. The lateral space between these multiple pairs of magnetic strips 125 may be at least about 1 cm.

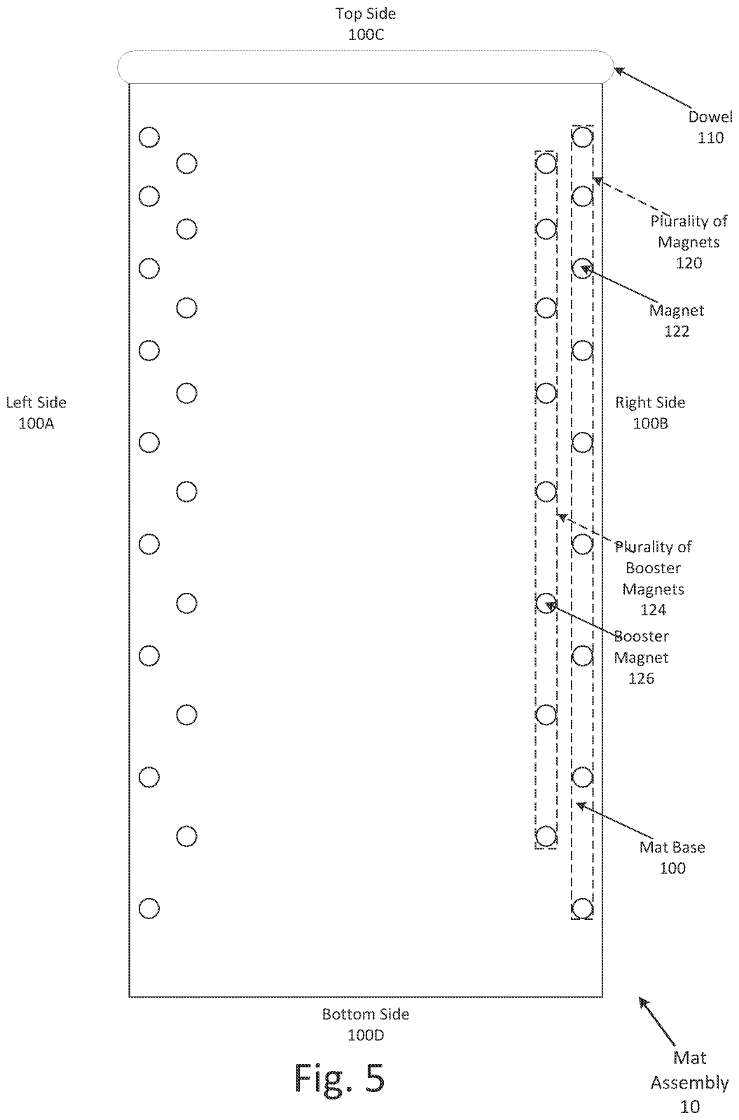

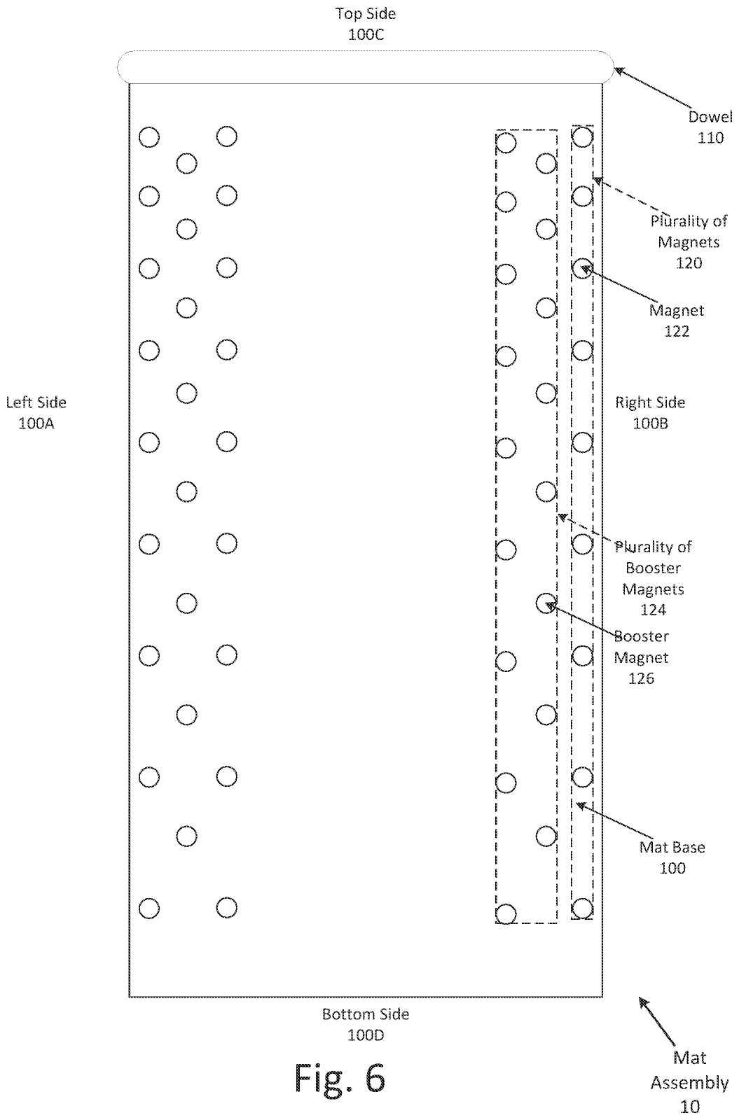

As shown in FIGS. 5-6, the mat assembly 10 may include a plurality of booster magnets 124 in addition to the plurality of magnets according to another exemplary embodiment. Each booster magnet 126 is positioned between a pair of magnets 122 (relative to the top side 100C or to the bottom side 100D) but is shifted a distance away from the plurality of magnets 120 (shifted to the right for the plurality of booster magnets 124 closer to the left side 100A and shifted to the left for the plurality of booster magnets 124 closer to the right side 100B). As shown in FIG. 5, in some embodiments, the plurality of booster magnets 124 may include a single additional column of booster magnets (i.e., ‘additional’ relative to the plurality of magnets 120), or, as shown in FIG. 6, in other embodiments, the plurality of booster magnets 124 includes two additional columns of booster magnets (i.e., ‘additional’ relative to the plurality of magnets 120). This plurality of booster magnets 124 increases the biasing force at each radian without increasing the risk of discomfort to the user that would come from using thicker or wider magnets in replacement of the plurality of magnets 120 to achieve the same biasing force. Utilizing the plurality of booster magnets 124 increases the surface area from which the magnetic force is generated without increasing the overall bulk of the mat assembly 10 with larger magnets.

In some embodiments, the plurality of booster magnets 124 are oriented in directions different from the plurality of magnets 120, such that the plurality of booster magnets 124 form a Halbach array with the plurality of magnets 120, thereby increasing a strength of the magnetic field generated by the plurality of magnets 120. In a Halbach array, the contrasting magnetic forces of magnets being arranged in various directions has the effect of strengthening the magnetic field in a certain direction while neutralizing the magnetic field in the opposite direction. By orienting the plurality of booster magnets 120 in a particular manner, the plurality of magnets 120 work together with the plurality of booster magnets 124 to strengthen the magnetic field away from the mat (i.e., axially outwards from the surface) and neutralizing the magnetic field into the mat (i.e., axially inwards from the surface).

In some embodiments, each magnet 122 and booster magnet 126 or each of the plurality of magnetic strips 125 is a permanent magnet that maintains its magnetic charge without a separate magnetic field or electrical current. In other embodiments each magnet 122 or each of the plurality of magnetic strips 125 is an electromagnet that generates its magnetic field in response to an electrical current. Each magnet 122 or each of the plurality of magnetic strips 125 has a grade or N number of between about N35 and about N55, where a higher grade or N number indicates a stronger attractive force and, therefore, a stronger magnetic force. In some embodiments, each magnet 122 is the same grade, while in other embodiments, the grade of the plurality of magnets 120 increases as they get farther from the dowel 110 (i.e. the set of the plurality of magnets labeled 208 are of a higher grade than the set of the plurality of magnets labeled 201).

In some embodiments, the plurality of booster magnets 124 have the same grade as the plurality of magnets 120. In those embodiments in which each magnet 122 is the same grade, each booster magnet 126 would also have the same grade. In those embodiments in which the grade of the plurality of magnets 120 increases as they get farther from the dowel 110, the grade of the plurality of booster magnets 124 similarly increases as they get farther from the dowel 110. In other embodiments, the plurality of booster magnets 124 have a different grade than that of the plurality of magnets 120. In some of these embodiments, the grade of each booster magnet 126 is less than the grade of each magnet 122. In other of these embodiments, the grade of each booster magnet 126 is greater than the grade of each magnet 122.

The plurality of magnets 120, the plurality of booster magnets 124, and the plurality of magnetic strips 125 may be coupled to the mat base 100 with an adhesive or sewn onto the mat base 100. In other embodiments, the plurality of magnets 120, the plurality of booster magnets 124, and the plurality of magnetic strips 125 are directly integrated into the mat base 100, either as a part of the original manufacture of the mat base 100 or through another process.

In some embodiments, the plurality of magnets 120, the plurality of booster magnets 124, and the plurality of magnetic strips 125 are located on the surface of the mat base. In these embodiments, the plurality of magnets 120, the plurality of booster magnets 124, and the plurality of magnetic strips 125 are encased in a thin layer of protective material to protect them from damage or cracking, as magnets generally are brittle and prone to crack with high impact. In other embodiments, the plurality of magnets 120, the plurality of booster magnets 124, and the plurality of magnetic strips 125 are embedded within the mat base 100 such that if the mat base 100 is formed by two layers of material, the plurality of magnets 120, the plurality of booster magnets 124, and the plurality of magnetic strips 125 are between the two layers of material. Further, for example, if the mat base 100 is formed by four layers of material, the plurality of magnets 120, the plurality of booster magnets 124, and the plurality of magnetic strips 125 are between the second and third layers. In these embodiments, the grade of each magnet 122 must be increased in order to maintain the required strength.

As discussed herein, one embodiment relates to a self-rolling mat comprising a mat base, a dowel coupled to the mat base at the top side on the front face, and a plurality of magnets coupled to the mat base along the left side and the right side on both the front face and the back face. The polarity of the magnets on the front face is opposite the polarity of the magnets on the back face, such that the front magnets are attracted to and couple with the back magnets as the mat is rolled around the dowel, thereby facilitating and expediting a more consistent rolling process and helping to prevent unrolling of the mat.

In some embodiments, the dowel acts as a starting point for the mat to be rolled so that the rolling process can be initiated by a user with their foot, which enables the user to roll up the mat without bending over and exerting extra effort. The weight of the dowel can compress the mat as it is rolled, removing excess air and ensuring a tighter roll. The fixed orientation of the dowel can help to keep the mat from rolling up in a lopsided manner and creating a telescope-like shape. Further, the mat may feature a set of magnets oriented away from the dowel and along the width of the mat that are configured to interact when the mat is in the fully-rolled position and to hold the mat closed (i.e, in the fully-rolled position).

In some embodiments, the mat includes a plurality of magnets that can help facilitate the rolling process. In these embodiments, the magnets are coupled to or integrally formed with the mat along the longer end of the mat. For example, the top facing surface of the mat may include magnets of a certain polarization (positive or negative) and the bottom facing surface of the mat may include magnets of the opposite polarization, such that the magnets on the top facing surface will be attracted to or biased toward the magnets on the bottom facing surface. As the mat is rolled, the magnets on the bottom facing surface will come into contact with and bias toward respective magnets from the top facing surface. Magnets closest to the dowel will bias toward each other first, and as they connect or attract toward each other as the mat is rolled, magnets farther away from the dowel will be moved close enough to each other to connect or bias toward each other until the mat is completely rolled.

In some embodiments, the magnets are continuous strips of magnets such that the magnetic material runs parallel to the longer side of the mat without interruption. In other embodiments, the magnets are each separate and discrete and are placed in intervals along the longer side of the mat. In some embodiments, the magnets are placed in regular intervals while in other embodiments the intervals are irregularly spaced. For example, the magnets may be arranged to having gradually increased spacing along a length of the mat, such that as the mat is rolled and the circumference of the rolled-up mat increases, each of the magnets will substantially overlap and couple to a corresponding magnet on the mat, so as to account for this increased circumference.

In some embodiments, the magnets are coupled to the mat (e.g., adhesively bonded, sewn, etc.). In other embodiments, the magnets are integrally formed with the mat, such as by being placed into a mold as the mat is being manufactured or produced.

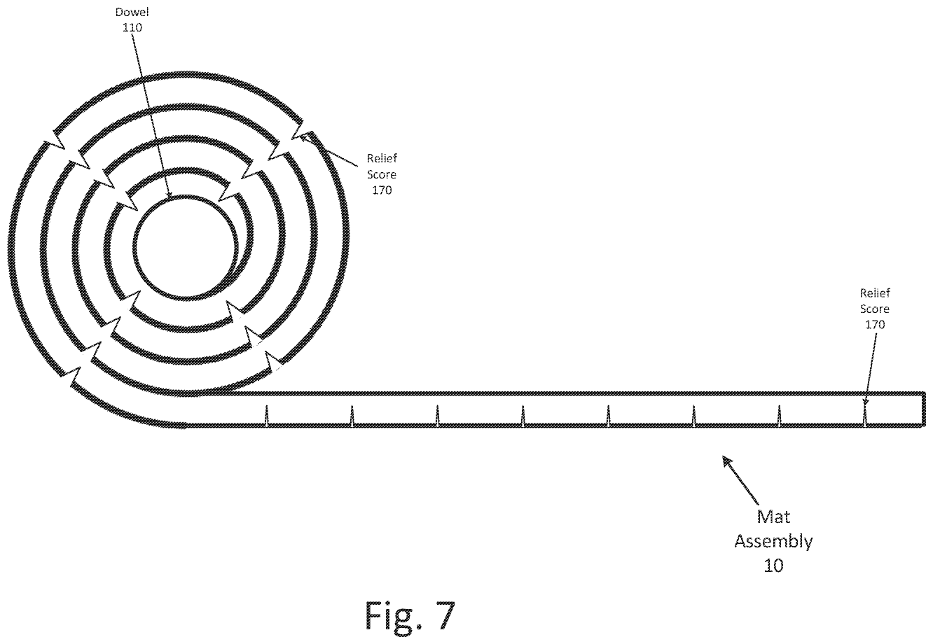

FIG. 7 illustrates the mat assembly 10 in a partially-rolled position according to an exemplary embodiment with a plurality of relief scores 170. As shown in FIG. 7, the relief scores 170 are located along the first surface (e.g., front surface) of the mat base 100. The plurality of relief scores 170 are slits made in the mat base 100. As such, the relief scores 170 may be constructed as part of the molding process (i.e., the mat base 100 is molded with the relief scores 170 included) or may be removed from the mat base 100 (e.g., with a blade, cutter, etc.) following the molding process. When the mat assembly is flat (i.e., unrolled), the plurality of relief scores 170 are slits in the mat base 100. However, as the mat assembly 10 is rolled, the plurality of relief scores 170 ‘open’ and appear as substantially triangular. In this way, the plurality of relief scores 170 ease the stretching force on the mat base 100 that occurs during rolling and prevent tearing or misshaping.

While this description has generally been directed to a mat for exercise or yoga, it should not be read as limited to those fields and could have applications for anti-fatigue mats in a kitchen or office, automotive maintenance mats, camping cot mats, mats for children play areas, anti-slipping mats for work areas, nursery school napping mats, electricians' anti-static and grounding mats, changing table mat, mats with distance markers for long jump practice, and anti-vibration mats in machinist shops.

No claim element herein is to be construed under the provisions of 35 U.S.C. § 112(f), unless the element is expressly recited using the phrase “means for.”

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, and/or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the tolerance compensators and the components/elements, as shown in the various exemplary embodiments, are illustrative only. Additionally, any element disclosed in an exemplary embodiment may be incorporated or utilized with any other embodiment disclosed herein. Although only one example of an element from an exemplary embodiment that can be incorporated or utilized in another embodiment has been described above, it should be appreciated that other elements of the various embodiments may be incorporated or utilized with any of the other embodiments disclosed herein.

What is claimed is:

1. A mat comprising:
a mat base defined by a length and a width, the length being greater than the width;
a first plurality of magnets coupled to a first surface of the mat base; and
a second plurality of magnets coupled to a second surface of the mat base.

2. The mat of claim 1, further comprising a dowel coupled to a first end of the mat, and
wherein the mat is configured to be rolled around the dowel along the length of the mat.

3. The mat of claim 2, wherein the dowel is formed as part of the mat base and is made of the same material as the mat base.

4. The mat of claim 1, wherein an operative magnetic direction of the first plurality of magnets is opposite an operative magnetic direction of the second plurality of magnets.

5. The mat of claim 4, wherein the first plurality of magnets are configured to interface with the second plurality of magnets as the mat is rolled along the length of the mat base around an axis formed by the width of the mat base.

6. The mat of claim 5, wherein each magnet of the first plurality of magnets and of the second plurality of magnets has an equal magnet grade.

7. The mat of claim 5, wherein a spacing between adjacent magnets of the first plurality of magnets increases along the length of the mat base.

8. The mat of claim 7, wherein the magnet grade of adjacent magnets of the first plurality of magnets increases along the length of the mat base.

9. The mat of claim 5, wherein a spacing between a magnet of the first plurality of magnets and an adjacent magnet of the first plurality of magnets is based on a radian angle measured on a substantially circular shape formed by the mat in a rolled position with the axis formed by the width of the mat base as a center of the substantially circular shape.

10. The mat of claim 5, wherein the first plurality of magnets and the second plurality of magnets each comprise a plurality of individual magnets utilizing a Halbach array, the plurality of individual magnets being arranged in a line substantially parallel to the length of the mat base.

11. The mat of claim 10, wherein the first plurality of magnets and the second plurality of magnets further comprise a plurality of booster magnets arranged in one or more lines substantially parallel to, and offset from, the plurality of individual magnets along the axis formed by the width of the mat base.

12. The mat of claim 11, wherein each magnet of the plurality of individual magnets and of the plurality of booster magnets has an equal magnet grade.

13. The mat of claim 11, wherein each magnet of the plurality of individual magnets has a first magnet grade, and each magnet of the plurality of booster magnets has a second magnet grade, wherein the first magnet grade is less than the second magnet grade.

14. The mat of claim 5, wherein the first plurality of magnets and the second plurality of magnets comprise a plurality of magnetic strips oriented substantially parallel to the length of the mat base.

15. The mat of claim 1, wherein the mat base comprises a plurality of layers of material, and wherein the first plurality of magnets and the second plurality of magnets are at least partially embedded between the plurality of layers of material.

16. The mat of claim 1, further comprising a plurality of batting strips arranged in parallel to the width of the mat base and along the length of the mat base, wherein the plurality of batting strips are configured to provide support to the mat.

17. The mat of claim 1, furthering comprising a plurality of securing magnets arranged at an end of the mat opposite of an axis formed by the width of the mat base around which the mat is rolled.

18. The mat of claim 17, wherein the plurality of securing magnets comprises one or more magnetic strips.

19. An exercise mat comprising:
a mat base defined by a length and a width, the length being greater than the width; and
a dowel coupled to a first end of the mat, wherein the mat is configured to be rolled around the dowel along the length of the mat.

20. A method for manufacturing an exercise mat, the method comprising:
providing a mat base defined by a length and a width, the length being greater than the width;
coupling a first plurality of magnets to a first surface of the mat base; and
coupling a second plurality of magnets to a second surface of the mat base opposite the front surface.
